(19) United States
(12) Patent Application Publication
(10) Pub. No.: US 2005/0174965 A1
(43) Pub. Date: Aug. 11, 2005

(54) Network optimization based on service behavior

(75) Inventors: Sinikka Sarkkinen, Kangasala (FI); Jari Isokangas, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/831,317

(22) Filed: Apr. 26, 2004

(30) Foreign Application Priority Data
Feb. 6, 2004 (EP) 04002687.4

(51) Int. Cl. H04Q 7/00

(52) U.S. Cl. 370/329; 370/236; 370/437

(57) ABSTRACT

The present invention relates to a method and system for allocating resources of a network portion through which service-related data flows are routed in a transparent manner, wherein the resource allocation is performed based on a service behavior classification information indicating the behavior of the service-related data flow during its lifetime and being forwarded to said network portion. Thereby, capacity and performance requirements during transparent transmission can be estimated more reliable.

### FIELD OF THE INVENTION

The present invention relates to a method and system for allocating resources of a network portion through which service-related data flows are routed in a transparent manner, such as a radio access network.

### BACKGROUND OF THE INVENTION

The support of multiple traffic classes with different Quality of Service (QoS) requirements poses new challenges in the field of network design. This is also true in the case of third generation (3G) mobile communications systems, especially in the access network, where radio and transmission resources are usually scarce.

FIG. 1 shows a schematic network architecture of a Universal Mobile Telecommunications System (UMTS), the European 3G mobile communication system, which comprises two parts: a UMTS terrestrial radio access network (UTRAN) and a core network (CN). UTRAN provides the air interface for UMTS terminals and the CN is responsible for switching and routing of calls and data connections to external networks.

UTRAN comprises one or more radio network subsystems (RNS) each comprising a radio network controller (RNC), several node B and user equipment (UE). The RNC is responsible for the control of the radio resources of the UTRAN and plays a very important role in power control (PC), handover control (HC), admission control (AC), load control (LC) and packet scheduling (PS) procedures, which are at least partially locate at the RNC. The RNC interfaces the CN via an Iu interface and uses Iub interfaces to control Node Bs. The Iur interface between RNCs allows soft handover between RNCs. The Node B is the 3G equivalent to a conventional base station. The Node B performs the air interface processing, which includes channel coding, interleaving, rate adaptation and spreading. The connection with the user equipment (UE) is made via a Uu interface, which is actually the WCDMA (Wideband Code Division Multiple Access) radio interface.

The CN integrates circuit and packet switched traffic. It comprises packet switched GPRS (General Packet Radio Services) nodes, i.e. a Serving GPRS Support Node (SGSN) and a Gateway GPRS Support Node (GGSN), for providing connection to external PS networks (e.g., IP and/or Multimedia networks) and corresponding circuit switched nodes, i.e. a Mobile Switching Center with Visitor Location Register (MSC/VLR) and a Gateway Mobile Switching Center (GMSC), for providing connection to external CS networks (e.g., PSTN, PLMN, ISDN). Other CN nodes are an EIR (Equipment Identity Register), a HSS (Home Subscriber Server) and an AUC (Authentication Center). The SGSN handles packet delivery to and from mobile terminals, and the GGSN is basically a packet router with additional mobility management features. The other elements of the CN will not be described in detailed here.

For UMTS, deploying an all-IP (Internet Protocol) architecture is a promising standardization trend due to the convergence between IP technologies and telephony services Streaming services are also technically supported over evolving second (2G) and third generation (3G) wireless networks, thus streaming clients will soon be deployed in advanced wireless communication devices.

Inside this new group of services, there exist a variety of applications (e.g. audio and video on demand) with different traffic source statistical characteristics. In case of audio streaming, the generated traffic is rather non-bursty whereas video traffic has a more bursty nature. One key issue is how mobile networks can support this kind of services. In these “Pre-All-IP” service cases the used radio bearers can be chosen from either 2G or 3G CS or PS bearer sets. PS bearers provide more trunking gain and better resources utilization while CS bearers offer better performance for those services with stringent delay requirements. All the multimedia services are mainly characterized by the necessity from the network point of view to guarantee certain Quality of Service (QoS) requirements.

In UMTS, all signaling associated with service session establishment is carried out by the control plane through different QoS management functions, i.e., bearer service management, subscription, translation and admission & capability. In the first place, a primary PDP (Packet Data Protocol) context is activated for RTSP (Real-Time Streaming Protocol) signaling using interactive UMTS traffic class. The interactive traffic class has a priority based handling instead of guarantees based handling, being the reliability requirement the target in this case. The control plane functions are distributed in different layers of several network entities. The QoS requirements of the application in the user equipment (UE) are mapped into 3G QoS attributes. Since the primary PDP context is used for RTSP signaling, a 3G QoS profile with interactive traffic class, high priority and low error rate is appropriate. A Session Management (SM) protocol message from the UE to the SGSN of the PS domain initiates the PDP context activation procedure. After the SGSN has validated the service for that user by querying the Home Location Register (HLR), local admission control is performed, e.g., based on the state of the buffers, the CPU load, etc. Then, the SGSN maps the 3G QoS attributes into Radio Access Bearer (RAB) QoS attributes and triggers a RAB assignment procedure in the RAN by using the Radio Access Network Application Protocol (RANAP).

In the RAN, admission control is basically based on the availability of radio resources. Once a new PDP context is accepted, RAB attributes are mapped into Radio Bearer (RB) parameters used in the physical and link layers (e.g. spreading codes, transmission modes, etc.). A RB according to these parameters is established and it is reported to the SGSN, which employs GPRS Tunneling Protocol for Control Plane (GTP-c) to indicate the GGSN that a new PDP context has to be created.

Today all application level services are transparent to the radio access networks. This situation is also valid for 3G networks, where UTRAN and RNC are not aware of the services behind each user plane data flow. This has lead to a situation where the system on the UTRAN side is designed only based on the optimization of the radio interface, and the services are only considered by the QoS parameters received from the CN via RANAP. But as long as the data are seen only through the QoS parameters, the behavior of the services and the subscribers using the service can be considered as an unpredictable element and cannot be taken into account in RNC implementation.

Even though the service itself is transparent to the UTRAN and RNC, the behavior of the service upon its lifetime is not. The behavior of the service has impact on the resources needed in the RNC, namely the questions what kind of transport channels is used, does it require a lot of channel switching, how intensive is the signaling, etc.

Because the UTRAN is not aware of the services behind the data flow, it is very difficult to judge what will be the needed capacity of the RNC to support different service mixes, e.g., speech service+video+online games+interactive gambling, which are defined by operators. The main problem today is that by using only the service mix information the following questions cannot be answered:
1. What shall be the average data amount transmitted upon service mix in question?
   => in the RNC: do we-used common channels or dedicated channels?
2. Does the service consist of multiple sub-sessions (i.e. data burst, between which there is a gap which exceeds the inactivity timers) or can it be seen as a one data flow?
   => in RNC: multiple sub-sessions increase signaling requirements—how much is needed depends on e.g. how many times the inactivity triggers in the RNC expires (one data flow is the optimal case from resource consumption point of view).
3. If multiple sub-sessions are supported, what shall be the gap between data burst?
   => in RNC: how many times the services are jumping between different RRC states (channel switching)? Each time when RRC state is changed, it causes both external and internal signaling in UTRAN/RNC
4. How many different data flows does the service require for the user plane?
   => in RNC: general estimation about the capacity amount used by the service from the total available capacity and about the performance requirements, i.e., what functions will be activated for the service upon its lifetime in the RNC?

These and may other questions are very difficult to answer, if each service has to be considered separately. Also, by considering the service only as an individual service after it has been introduced, it is very difficult to estimate how the system should be improved in the future to support also such services.

However even though the service behavior is very important aspect to the RNC/UTRAN performance/capacity/dimensioning etc., today no tools or rules are available to verify different service behavior upon its lifetime at the RNC. Without any knowledge about the service characteristics compared to the UTRAN behavior, the quality of service, e.g. delay to establish the connection, delay to continue the service and the like, experienced by the subscriber may decrease unexpectedly due to resource handling schemes in UTRAN. Hence, the optimal division between control and user plane data load is difficult to achieve.

### SUMMARY OF THE INVENTION

It is therefore an object of the present invention to provide a method and system, by means of which RAN network performance can be optimized.

This object is achieved by a method of allocating resources of a network portion through which service-related data flows are routed in a transparent manner, the method comprising the steps of forwarding to the network portion a service behavior classification information indicating the behavior of the service-related data flow during the lifetime of the service-related data flow; and allocating or configuring the resources of the network portion in dependence on the service behavior classification information.

Furthermore, the above object is achieved by a network device for controlling resource allocation in a first network portion through which a service-related data flow is routed in a transparent manner, the device comprising evaluating means for evaluating a service behavior classification information received from a second network portion indicating the behavior of the service-related data flow during the lifetime of the service-related data flow; and allocating means for allocating the resources of the network portion in dependence on the service behavior classification information.

Additionally, the above object is achieved by a server device for forwarding a service-related data flow through a network portion in a transparent manner, the device being configured to forward to the network portion a service behavior classification information indicating the behavior of the service-related data flow during the lifetime of the service-related data flow.

Accordingly, by introducing the service behavior classification information, the service mix becomes transparent to the RNC and network operators are enabled to convert their service mix into different service behavior classes, so that RNC estimation can be made based on a mix of service behavior classes of different service-related data flows. When new services are introduced by network operators, only the percentage of certain service behavior classes is changed, kept the same or decreased, and therefore resource allocation or implementation of network deices may follow only the development of the service behaviors class grade, while the services behind each class can be kept unknown.

One service behavior class can consist of different kinds of services, which have approximately the same service profile upon their lifetime. When weight of one service is decreased the weight of another service may increase by keeping the total importance of the class the same. I.e. services can come and go and no impact is seen in the allocation of network resources. Moreover, it is much easier to handle a few service behavior classes than a huge number of different services.

The service behavior class principles can be implemented in an RNC, so that it should be possible to measure how much traffic or radio access bearers are belonging into each class. This information can be used for RNC optimization Thus, together with the QoS information the RNC capacity and performance can be estimated more reliable.

The resource allocating may comprise optimizing at least one of system and network elements of the network portion based on the service behavior classification information. In particular, the system optimization may comprise configuration of at least one of a base station, a common channel, and a cell. The optimization of network element may comprise allocation of network element resources for different use.

As an alternative or additional measure, the resource allocation may comprise at least one of selecting, modifying and establishing an access bearer.

Furthermore, the classification information may define at least one of a continuance, a data amount, a length of idle periods, and a number of flows of said service-related data flow. In particular, the continuance may specify whether or not the service-related data flow is divided into sub-sessions, the number of flows may specify whether the service-related data flow consists of one flow or more than one flow, the data amount may specify whether the service-related data flow consists of more or less than a predetermined amount of data, and the length of idle periods may specify predetermined ranges of time periods.

The network portion may be a radio access network. As an example, the classification information may be forwarded in a bearer setup request, or any other RANAP signaling message of the radio access network.

The above object is also achieved by a system for allocating resources of a network portion through which service-related data flows are routed in a transparent manner, the system comprises a network device which comprises a) evaluating means for evaluating a service behavior classification information indicating the behavior of the service-related data flow during the lifetime service-related data flow, and b) allocating means for allocating the resources of the network portion in dependence on the service behavior classification information; and a server device being configured to forward to the network portion the service behavior classification information indicating the behavior of the service-related data flow during the lifetime of the service-related data flow.

### BRIEF DESCRIPTION OF THE DRAWINGS

In the following, the present invention will be described in greater detail based on a preferred embodiment with reference to the accompanying drawings, in which:

FIG. 1 shows a schematic block diagram of a network architecture in which the preferred embodiment of the present invention can be implemented;

FIG. 2 shows a schematic functional block diagram of a bearer establishment procedure according to the preferred embodiment; and

FIG. 3 shows a table of an exemplary service behavior classification according to the preferred embodiment.

### DESCRIPTION OF THE PREFERRED EMBODIMENTS

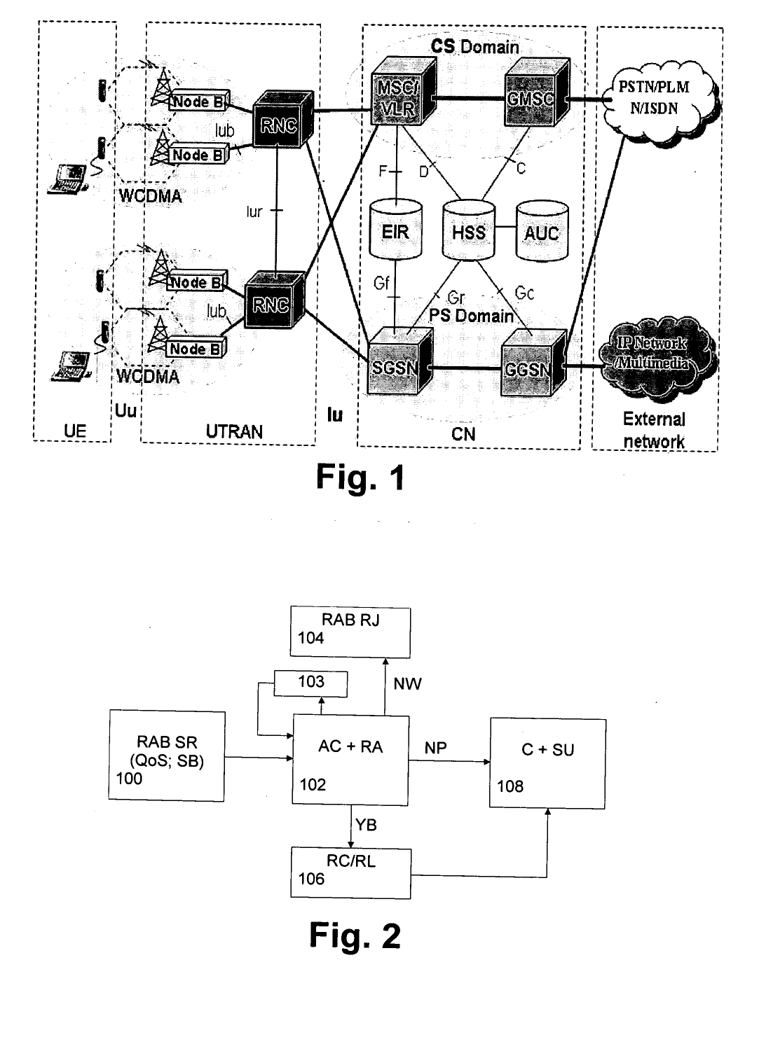

The preferred embodiments will now be described on the basis of a bearer establishment procedure in a UMTS network architecture as shown in FIG. 1.

To optimize the usage of radio interfaces, UTRAN resources are established and released on a demand basis. According to the preferred embodiment, besides the current traffic classes (conversational, streaming, interactive, background) and QoS parameters, demand are based on new classes which describe the behavior of the services during their lifetime. These classes could be categorized e.g. as service behavior classes.

The use of the service behavior classes means that each service is evaluated and categorized into a specific service behavior class which may represent, e.g., a certain type of parameter set in the RNC. The used parameter set may be based on the behavior of the RNC in different situations. When the parameter set is known, also the load and capacity requirements for the system in the UTRAN and in the RNC can be evaluated. Thus, the basic idea is to evaluate the services from the RNC's functionality point of view.

By doing this, the service can be kept transparent to the RNC/UTRAN, but in the UTRAN, the service aspect also can be taken into account when the system is designed and/or dimensioned. Based on the QoS parameters together with the service behavior classes, the resources needed by certain services are better known and this information can be used for system and/or RNC optimization and further implementation purpose.

Thereby, the service behavior classes can be regarded as the UTRAN way to take services into account without getting knowledge of the service itself.

In the following, a radio bearer establishment procedure according to the preferred embodiment will be described with reference to FIG. 2.

FIG. 2 shows a schematic functional block diagram of the bearer establishment procedure. This functional block diagram describes the functionalities provided in a radio network controlling device of a RAN, such as the RNC, which is responsible for allocation, management and termination of radio bearers. In particular, radio bearers are established when radio access bearer (RAB) establishment is requested by the CN, e.g. by an SGSN of the PS domain, as indicated by the functional step 100. The corresponding RAB setup request comprises specific QoS parameters and a specific service behavior class allocated to the service for which the radio bearer is requested. As an alternative, the service behavior class information can be fetched e.g. from the operator or it can be measured from the traffic itself.

A resource manager functionality 102 in the RNC, which is responsible for admission control and resource allocation, first determines whether there are enough resources to service the request. If there is no capacity problem (NP), the selected radio bearer is configured and set up (functional step 108). In particular, the resource manager functionality 102 selects an appropriate radio bearer according to the QoS values of the parameters and the service behavior class specified in the RAB setup request.

If there is a conditional capacity problem (YB), an existing radio access bearer with lower priority may be degraded (reconfigured) or released (functional step 106) so as to allow selection and establishment of the new radio bearer. Alternatively, if there is no way (NW) to provide or free the required capacity, the setup request will be rejected with a corresponding response message including a notification of the cause (functional step 104). As another possible option, the resource manager functionality 102 may put the setup request into a waiting queue 103, to start the establishment procedure again at a later point in time.

A radio bearer is specified by the type of channel it is using, the parameters describing this channel and the configuration of the radio protocols. There are two main types of channels, dedicated channels for time stringent traffic and shared channels for non-time stringent traffic. When deploying a dedicated channel the access to this channel is restricted to the owner of the bearer. The channel is also specified by the frequency and the CDMA (Code Division Multiple Access) codes. These codes define raw data-rate on the channel. Furthermore, error coding is used and additional redundancy may be provided at the radio link layer control function by a retransmission protocol. The choice of the error coding code and whether to use retransmissions or not depends on the level of reliability needed for the radio bearer and the delay requirements. Any mapping function can be used for allocating the QoS parameter and service behavior class given in the radio access bearer set-up to a specific radio bearer to be selected.

With the aid of new service behavior classification, the UTRAN behavior with different service mixes can be estimated. By knowing the percentage of each class the network operator can tune the system (i.e. RNC) to work in most optimal way. E.g., if the traffic profile transmitted via e.g. the RNC is expected to transfer the biggest load via common channels, then the operator should configure more resources to the common channels and define the corresponding parameters to fit data transmission on common channels. If the situation is vice versa, i.e. only dedicated channels are needed, then some resources can be taken from the common channels and this extra resource can be allocated to the dedicated channels.

Furthermore, the service behavior class or category can be taken into account during RAB allocation or establishment or when the RNC is configured, e.g. inactivity timers can be tuned to fit to majority of the services, which may decrease signaling load.

The possible bottlenecks—caused by different kind of service data flows—are easier to detect by the RNC, e.g. input and/or feedback can be provided for both RNC application and platform implementation. This provides increased general understanding how services are to be handled in the system including UTRAN.

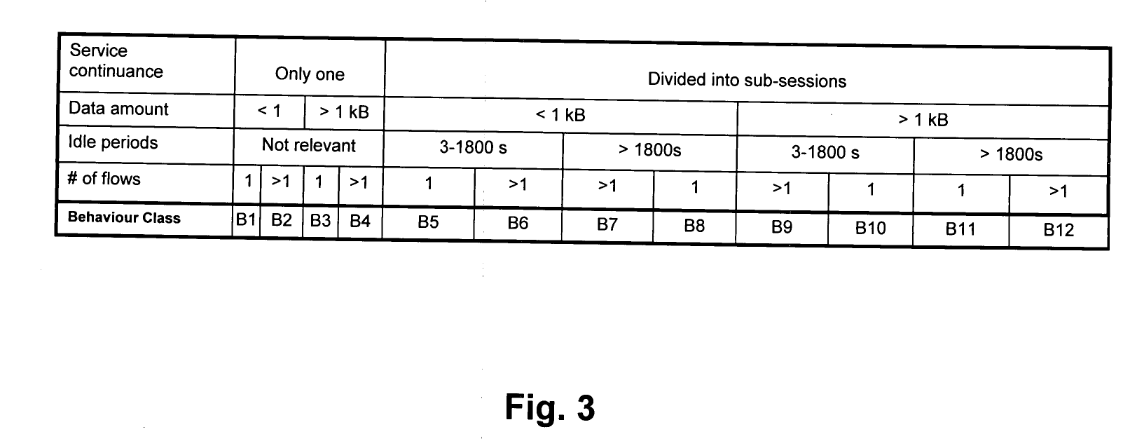

FIG. 3 shows a table of an exemplary classification for the services based on how they are seen from radio interface/RNC behavior point of view. Important parameters which impact to the radio interface/RNC behavior are:
1. Continuance of the service:
   From the radio interface point of view the service either has assigned resources or not. The release of the resources is controlled by monitoring the occupancy of the resources. I.e., a service which generates idle periods between data bursts may, from air interface point of view, be seen as a non-continuous service, even if the service is active from PDP context point of view.
2. Idle periods:
   When the resources are not used due to non-activity of the application, the resources are released from the air interface and the Iub interface. Depending on how long the bearer is inactive the UE goes to one of the states RRC Connected (UE is known in UTRAN), Cell-FACH (only common resources are available, which limits how much user plane data is possible to be sent through CCH), Cell-PCH (for UE no resources have been assigned and it is not allowed to use CCH resources either. UE has to be paged from the cell), URA-PCH (for UE no resources have been assigned and it is not allowed to use CCH resources either. UE has to be paged from URA (UTRAN Routing Area), RRC Idle (UE is known only in CN, but not known in UTRAN even if it may have a PDP context at CN side), and RRC Connected/Cell-DCH state (used only when radio bearer has assigned resources for data transmission).
3. Data Amounts:
   Based on the received data amount upon RAB establishment (or wake up of the existing RAB), the RNC will select the most appropriate transport channel for the service, e.g., a common channel (services under 1 kB (today under 128 byte) are allowed to use CCH), a dedicated channel (all RT traffic and NRT traffic, which is not allowed to use CCH is transmitted by using DCHs), and HSDPA (High Speed Downlink Packet Access).
4. Number of connections or flows:
   The number of required connections defines how much resource the RNC should be able to provide for the radio bearers belonging to same service.

As can be gathered from the exemplary classification table of FIG. 3, twelve service behavior classes B1 and B12 with different parameter values for the above parameters service continuance, data amounts, idle periods, and number of flows. In particular, the first service behavior classes B1 to B4 are distinguished by the amount of data and the number of flows, while only one service is provided and idle periods are not relevant. The remaining service classes B5 to B12 are all related to services which are divided into sub-sessions, and are divided into classes B5 to B8 and B9 to B12 by their amount of data. Further respective divisions into sub-groups of service behavior classes can be made based on the lengths of the idle periods and the number of flows.

It is noted that the present invention is not restricted to the preferred embodiments described above. The present invention may be implemented in any access network where resource or capacity allocation has to be performed for connection establishment or device implementation for transparent connections. The service behavior classification may be based on only one or more of the above parameters or on any other parameters suitable to describe the behavior of concerned services. The embodiments may thus vary within the scope of the attached claims.

1. A method of allocating resources of a network portion through which service-related data flows are routed in a transparent manner, said method comprising the steps of:
a) forwarding to a network portion a service behavior classification information indicating the behavior of a service-related data flow during the lifetime of the service-related data flow;
b) allocating or configuring said resources of said network portion in dependence on said service behavior classification information.

2. The method according to claim 1, wherein said resource allocating step further comprises the step of optimizing at least one of system and network elements of said network portion based on said service behavior classification information.

3. The method according to claim 2, wherein the step of optimizing the system further comprises the step of configuring at least one of a base station, a common channel, and a cell.

4. The method according to claim 2, wherein the step of optimizing the network elements further comprises the step of allocating network element resources for different use.

5. The method according to claim 1, wherein said resource allocation step further comprises the step of performing at least one of selecting, modifying and establishing an access bearer.

6. The method according to claim 1, wherein further comprising the step of defining, by the classification information, at least one of a continuance, a data amount, a length of idle periods, and a number of flows of said service-related data flow.

7. The method according to claim 6, wherein said continuance specifies whether or not said service-related data flow is divided into sub-sessions.

8. The method according to claim 6, wherein said number of flows specifies whether said service-related data flow consists of one flow or more than one flow.

9. The method according to claim 6, wherein said data amount specifies whether said service-related data flow consists of more or less than a predetermined amount of data.

10. The method according to claim 6, wherein said length of idle periods specifies predetermined ranges of time periods.

11. The method according to claims 1, wherein said network portion is a radio access network.

12. A network device for controlling resource allocation in a first network portion through which a service-related data flow is routed in a transparent manner, said device comprising:
a) evaluating means for evaluating a service behavior classification information indicating the behavior of said service-related data flow during the lifetime of the service-related data flow; and
b) allocating means for allocating said resources of said network portion in dependence on said service behavior classification information.

13. The device according to claim 12, wherein said network device is a radio network controller.

14. The device according to claim 12, wherein said classification information defines at least one of a continuance, a data amount, a length of idle periods, and a number of flows of said service-related data flow.

15. The device according to claim 12, wherein said first network portion is a radio access network and said second network portion is a core network.

16. A server device for forwarding a service-related data flow through a network portion in a transparent manner, said device being configured to forward to said network portion a service behavior classification information indicating the behavior of said service-related data flow during the lifetime of the service-related data flow.

17. The device according to claim 16, wherein said server device is a Serving GPRS Support Node.

18. The device according to claim 16, wherein said classification information defines at least one of a continuance, a data amount, a length of idle periods, and a number of flows of said service-related data flow.

19. The device according to claim 16, wherein said network portion is a radio access network.

20. A system for allocating resources of a network portion through which service-related data flows are routed in a transparent manner, the system comprises:
a network device which comprises
a) evaluating means for evaluating a service behavior classification information indicating the behavior of the service-related data flow during the lifetime of the service-related data flow, and
b) allocating means for allocating the resources of the network portion in dependence on the service behavior classification information; and
a server device being configured to forward to the network portion the service behavior classification information indicating the behavior of the service-related data flow during the lifetime of the service-related data flow.
